(19) United States
(12) Patent Application Publication
(10) Pub. No.: US 2002/0198809 A1
(43) Pub. Date: Dec. 26, 2002

(54) System and method for managing investment accounts for a financial institution which provides investment assistance to individual client investors

(76) Inventors: R. Michael Daley, Seattle, WA (US); Ravindra A. Deo, Mercer Island, WA (US)

Correspondence Address: JENSEN + PUNTIGAM, P.S., SUITE 1020, 2033 6TH AVE, SEATTLE, WA, 98121, US

(21) Appl. No.: 09/864,415

(22) Filed: May 23, 2001

(51) Int. Cl. G06F 17/60

(52) U.S. Cl. 705/36; 705/35

(57) ABSTRACT

The system involves the management of small investment accounts on behalf of a third party financial intermediary by a system financial service provider. The system is available on a global computer network at an internet site which is accessible to client investors of a financial intermediary through a link from an internet site of the financial institution. A first portion includes a series of questions to develop a risk profile of the client investor. From the risk profile, a suggested investment solution is determined by the system from a plurality of investments, such as various mutual funds, available from the financial service provider. The second portion provides information relating to the suggested investment, including a profile of typical investors and risk/return characteristics. A third portion, with information from the client investor, results in a completed investment application, which, when signed by the investor and forwarded to the financial service provider, opens an investment account which is established and maintained by the financial service provider on behalf of the financial intermediary for its client investors.

### TECHNICAL FIELD

This invention relates generally to investment systems, and more particularly to internet-based investment systems.

### BACKGROUND OF THE INVENTION

Most financial institutions, including, for instance, banking institutions, broker/dealers and other financial investment organizations, provide investment advice and assistance in obtaining investments for individual investor clients. Mutual funds are often attractive to such individual investors, due to their inherent diversification and their relatively low cost. Many of these investor clients are in a “small account” category, the definition of which may vary from institution to institution, but which generally means less than $500,000. These accounts, particularly the very small accounts, in the several thousand dollar range, create difficulties for many financial institutions since, while they do generate revenue, the revenue may not be sufficient to cover the costs associated with adequately serving and administering the account. The financial institution, while providing mutual funds as one investment choice, may encounter a low or even negative profit margin on the accounts, due to the service costs involved.

Generally, the costs which are associated with servicing investment accounts (including the “small” accounts) are divided into three general categories: professional, administrative and technology resource. The professional costs involve human time, including personal interaction time with the client, which will include education of the client, determination of appropriate investment allocation and risk level and periodic review of the client's financial situation. Administrative costs generally include human time and expense in completing required paperwork to establish each account, providing periodic statements and other service information for each client investor and entering data into the overall investment system of the financial institution servicing the client investor. In the technology resource area, data bases and software must be purchased and/or developed, as well as accounting and tracking systems, in order to provide appropriate and/or required information and tracking of the individual investor clients and their selected investments and accounts.

For the above reasons, so-called small accounts are not preferred by financial institutions, thereby limiting access to such financial institutions for some small investors.

It is desirable, therefore, to have a system which would reduce the costs involved on the part of the financial institution for such accounts so as to make small accounts more acceptable, and even desired.

### DISCLOSURE OF THE INVENTION

Accordingly, the present invention is a system for managing small investment accounts involving a financial service provider, a third party financial intermediary and direct investors associated with the financial intermediary, using a global computer network, wherein the financial service provider hosts the system on behalf of one or more third party financial intermediaries, the system comprising: a first portion, available on the global computer network, which includes a number of questions to be answered by a client investor, directed toward developing a risk profile of the client investor, which permits a corresponding investment recommendation to be made from a plurality of possible investments; a second portion, also available on the global computer network, for providing selected information concerning said investment recommendation to the client investor; and a third portion, also available on the global computer network, for completion of an investment application by the client investor and for subsequent transmittal thereof to the financial service provider, which opens and maintains an investment account for the client investor on behalf of the financial intermediary, with substantially no further involvement by the financial intermediary.

### BRIEF DESCRIPTION OF THE DRAWINGS

FIG. 1 is a simplified flow chart of the system of the present invention.

FIG. 2 is a more detailed flow diagram of the overall control/function of the system of the present invention.

### BEST MODE FOR CARRYING OUT THE INVENTION

The present invention is a system directed toward servicing certain financial institutions, referred to hereinafter as financial intermediaries, which provide investment services to small, individual client investors, primarily by recommending and actually purchasing particular investments appropriate for the client investor. The financial institution will also, of course, typically service larger accounts. As an example, a typical financial intermediary would be a bank in a given community; the client investor would typically be an individual having one or more existing accounts with the financial intermediary.

The type of investment that is often most attractive to the small client investor and which is therefore the focus of the present system is the mutual fund. A variety of mutual funds will typically be made available for investment under the present system, with the particular mutual fund investment or investments (from the several available) to be made by the client investor being determined through a series of system steps discussed in detail below. An organization using the present system to service financial intermediaries for the benefit of their individual client investors is referred to herein as the financial service provider.

The present invention, as described in detail below, comprises a three-party arrangement, involving a financial service provider, a financial intermediary to which the operation of the present system is directed and individual client investors of the intermediary who receive the assistance/support of the system in making investment decisions and transactions.

In overview, the present system includes four separate portions, the operation of which is, relative to the financial intermediary, to relieve a substantial amount of the cost of servicing individual investment accounts of its client investors, thus making it possible for the financial intermediary to offer to its smaller client investors the possibility of investing in mutual funds or other investments. The first portion is referred to as a preamble and involves both investment education in the form of information for the client investor and any necessary legal disclosures. While this portion is important to the overall investment process for the investor client it is not a necessary portion of the present invention, as the purpose of this portion of the system can be accomplished by the financial intermediary in ways other than by using this portion of applicant's system.

The second portion of the present system is a risk questionnaire which is provided to the client investor to establish the client's risk tolerance or profile, i.e. the degree of investment risk that is appropriate for the client investor, given the existing circumstances/concerns of the client investor.

The third portion of the present system comprises detailed, customized investment information concerning the specific investment program recommended by the system in response to the risk profile of the investor client generated by the system.

The fourth portion of the present system initiates the establishment of the investment account; necessary information to establish the investment account is obtained from the client investor in this portion.

As indicated above, the financial service provider hosts the system of the present invention on behalf of the financial intermediary. The various individual portions of the system are implemented over a global computer network (internet) system from a network site established by the financial service provider. As described in more detail below, all needed information to establish an investment account for a client investor is provided over the global computer network by the client investor, typically in the presence of an investment professional. The information required by the financial service provider from the client investor is obtained by means of the internet. When the client investor signs the completed application form made available to him/her from the internet site, and that signed application has been transmitted along with appropriate payment to the financial service provider, the financial service provider opens up an account based on the one- time-only entered information. The financial service provider thereafter performs certain required services and provides information to the individual client investor, thereby relieving the financial institution (intermediary) of the costs of providing such services. The present system relieves financial intermediaries such as individual banks from certain costs associated with servicing small client investors, so that financial intermediaries will be more willing to offer investment solutions, typically available from the financial service provider, to their small client investors.

Typically, the system of the present invention functions as follows. The financial service provider will construct a site on the global computer network for each of its financial intermediary clients. For instance, a financial intermediary may be a particular bank in a given city. The global computer network site for that bank constructed by the financial service provider will typically be customized so that it will be recognizable in comparison to the bank's own site; it will typically not indicate that it is in fact a separate site from the bank's own site.

The client investor of a particular bank will typically log on to the bank's network site on the existing internet. Typically, they will do this at the bank's facility, in the company of a professional financial representative/employee of the bank. They will then link from the bank's site to the financial service provider's associated website for that bank, which, as indicated above, will typically be complementary to the bank's site. Typically, as stated above, the financial service provider will maintain separate internet sites for each of its financial intermediary clients.

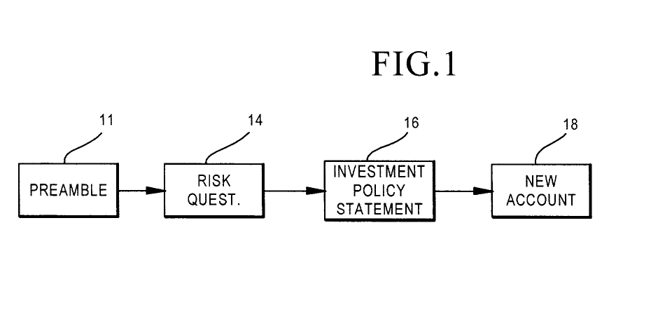

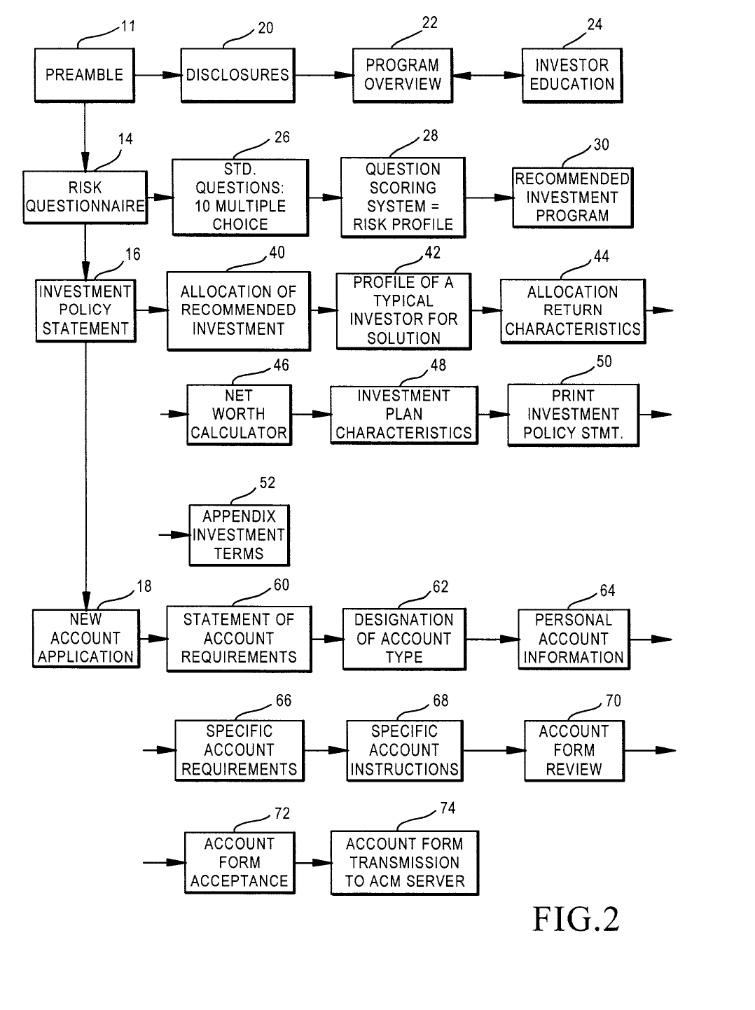

FIG. 1 shows a simplified diagram of the functional flow of the system of the present invention. FIG. 2 shows a more detailed representation of the system flow and serves as a basis for the control program of the system. In block 11 in FIGS. 1 and 2, at the point where the client investor is viewing on-line the financial service provider's customized network site, typically at the financial intermediary's location, preamble information will be provided to the client investor by a first portion of the system of the present invention. The purpose of the preamble portion is to inform and educate the individual client investor. In the absence of the present system, an investment professional would provide that information through various means, such as through face-to-face meetings or seminars, information/telephone conversations, or other means, in order to provide investment education to the client investor, as part of the sales process.

The preamble portion of the present invention can be used as a complement or an alternative to such professional, face-to-face presentations. The investment professional can also use, if desired, various materials, including charts, multimedia presentations, brochures or other marketing materials, to accomplish the education function in addition to the system preamble portion. The preamble can also be used substantially by itself, but typically in the presence of an investment professional. The preamble portion is thus not an essential part of the system of the present invention (the system can be used without it if the purpose is accomplished by other means), but it certainly can be included in the system if desired. The overall length of the preamble will depend upon the requirements of the financial intermediary. As indicated above, this portion of the system can be eliminated completely, should the financial intermediary utilize investment professionals to provide the required education in other ways.

Typically, preamble portion 11 will first include several specific client disclosures (block 20). If the financial institution is a bank, for instance, the client investor must be informed that the financial products being offered are not obligations of the bank and are not insured by the F.D.I.C.

Also, the typical mutual fund disclosures will be made concerning the possibility of the client investor losing money as well as information concerning past performance and expected future results of the investments. Typically, at the end of the disclosure portion of the preamble, there will be a portion for the client investor to sign, acknowledging that the information has been read and understood. The signature portion will be printed from the internet site, signed by the client investor and maintained in the files of the financial intermediary.

The remaining pages of the preamble, beyond the necessary disclosures, can include an overview of the program (block 22) and a wide variety of educational material/information (block 24). The preamble may vary in length significantly, depending upon its purpose and the amount of education material provided. Typical topics in the preamble, for instance, might include a discussion of the overall financial process (block 22) of the present system as well as a description of the possible investments being offered through the financial intermediary. The actual investments generally will be proprietary products of the financial service provider, but could be proprietary products of others. For instance, there may be several (e.g. six) different mutual funds available, which have various mixes of individual investments and are tailored to particular risk levels. The several mutual funds as a group would thus cover a wide range of risk. The preamble could provide an explanation and a description of each mutual fund (or other possible investment), in as much (or little) detail as desired by the financial intermediary.

Additional information might include definitions of key terms in the world of investments as well as other general investment information. Again, the preamble portion can vary substantially, depending upon the desire and strategy of the financial intermediary.

The key concept/purpose of the preamble is to (1) provide the required disclosures for the particular financial intermediary being served, (2) have the investor client sign an acknowledgment of receipt of the disclosure information and, in addition, (3) provide information concerning the overall investment program and options open to the client investor and selected general investment information, so that the client investor can make an informed decision with respect to a particular recommended investment solution, i.e. plan.

Following the preamble is what is referred to as a risk questionnaire portion, referred to at 14 in FIGS. 1 and 2. The purpose of the risk questionnaire is to determine the risk profile of the client investor so that the system can determine/suggest an appropriate investment among the several available from the financial service provider. Typically, the present system will include a specific risk questionnaire which will consist of a plurality (e.g. 10) of multiple choice questions (block 26). Each question will have several answer choices, with each answer having a particular numerical score associated with level of risk. The numerical scores will then be totaled by the system to produce a “risk profile” score (block 28).

The lower numbers typically represent individuals with lower risk profiles. A score of 10 would represent an investor with a very low risk profile, which indicates that such an investor requires a very low probability of loss of principal over a market cycle, while a score of 40 indicates the investor has a very high risk profile and is able to accept high levels of volatility of principal, in exchange for potentially higher, long-term average returns. A sample distribution of scores and associated risk is as follows for illustration; adjustments can be made to this scale, depending on the questions and the values assigned to particular answers.

| Questionnaire Score | Risk Level |
|---|---|
| 10-12 | Lowest |
| 13-16 | Low |
| 17-22 | Moderate-low |
| 23-30 | Moderate |
| 31-37 | High |
| 38-40 | Highest |

Typically, the lowest risk range will provide an investor with a fixed income/cash mutual fund solution, while the highest risk range will provide the investor with an all-equity mutual fund solution, with the equities being aimed toward long-term growth instead of more conservative (i.e. income) criteria. The risk questions are basically designed to produce a normal distribution of results, with the majority of the results being in the 17-30 range, while aggressive investors will score in the 30-40 category and the more risk-adverse investors will score in the 10-16 range. The risk questionnaire is intended to identify a level of risk appropriate for the client investor, not necessarily the level of risk which may be desired by that individual.

Two questions from a single risk questionnaire, for purposes of illustration, are as follows: (A) If you invested $100,000 and shortly thereafter the market experienced a decline, at what point would you liquidate and move to a more stable investment? (1) immediately (1 point), at $90,000 (2 points), (3) at $75,000 (3 points), (4) never, i.e. would wait for the market to turn around regardless of the loss (4 points); (B) How optimistic do you feel about your financial future? (1) pessimistic (1 point), (2) unsure (2 points), (3) positive (3 points), (4) very optimistic (4 points). Other questions might inquire as to the types of investments purchased in the past, expectation of change in household income and the date when the money being invested is expected to be accessed.

The standard questionnaire in the system of the present invention has a series of ten questions aimed at determining the risk profile of the client investor. The questions provided by the system can be modified or changed by the financial intermediary to suit its particular client investor base or its own investment perspective. The questions are intended to be customizable; also, there may be fewer or greater than ten questions. The important concept/purpose of the questionnaire portion of the system is to provide an opportunity for the client investor to easily and quickly provide information by which the system can determine the risk perspective (profile) of the client investor.

From the answers to the risk questionnaire, the present system will then choose a particular investment solution or plan from among the several available in the system (block 30). For instance, a particular financial service provider using the present system may have six/seven or more different mutual funds (or other specific investments) available, each with a specific known/assigned level of risk determined by the particular mix of investment products in that fund. The present system will then match up the particular risk profile of the individual client investor determined by the risk questionnaire with a particular corresponding investment product or products. The investment product(s) could be those of the service provider (proprietary investments) or from some other source (non- proprietary investments).

With respect to the determination of the risk profile for each client investor, each financial intermediary has the ability under the present system to allow their individual client investors to override to some extent either the risk profile determination and/or the particular suggested investment. If a change is made to the risk profile by changing the answers to the questionnaire, the recommended investment will change accordingly. The investment decision may also be directly altered to either a slightly more conservative or less conservative choice. The decision is left to the client investor.

The next portion of the system of the present invention, following the risk questionnaire and the resulting investment recommendation, is known as the investment policy statement, shown at block 16 in FIGS. 1 and 2. The primary purpose of the investment policy statement is to inform the client investor in detail concerning the particular investment solution recommended, as well as providing disclosure of its risk and return characteristics. This section can also vary in the amount of information provided, depending upon the choice of the particular financial intermediary, but it should include most of the following, in addition to a statement of the actual investment (block 40).

The investment policy statement describes the risk profile of the typical investor who invests in the recommended investment (block 42), as well as anticipated return/risk calculations based on the various asset classes (stocks, bonds, cash) in which the particular mutual fund is invested (block 44). As indicated above, at block 40, each mutual fund solution will be characterized by a different mix of stocks, bonds, etc. The investment policy statement may also include what is referred to as a net worth calculator for the particular investment recommendation (block 46), in which the projected growth of the investment recommended over a particular selected time is set out, including the projected cash flow by the client investor into the recommended investment. A historical return/risk portion may also be included which explains the historical volatility (change) and return of various market indices for the particular investment. This can be summarized as the investment plan characteristics (block 48).

The investment policy statement will also typically include informational topics, including the benefits of the particular investment, as well as some overall characteristics of investing in stocks, bonds and cash. The investor's answers to the risk questionnaire may also be set out in the system embodiment shown, although this is not necessary. The investment policy statement with the investment information is then printed out (block 50), usually at the location of the financial intermediary. The printed document is then reviewed by the client investor and then signed. An appendix of investment terms is also provided (block 52).

The investment representative/professional, acting on behalf of the financial intermediary, will maintain a copy of the signed IPS (Investment Policy Statement) for the records of the financial intermediary. The client investor also keeps a copy for his/her records. The signature of the individual investor indicates they have read the IPS and agree with the investment recommendation, given all the information provided in the investment policy statement itself. The investment representative also has the opportunity to sign the policy statement. This completes this portion of the system.

The last portion of the system is the new account portion. Typically, it follows, in sequence, the risk questionnaire portion, the investment recommendation and the investment policy portion. The new account portion, shown at block 18 of FIGS. 1 and 2, obtains all the required client investor information to complete the transaction and permit the actual investment in the selected mutual fund or funds to be made.

The new account portion of the system of the present invention is for mutual funds, as opposed to individual securities. The new account portion thus gathers all the necessary client information to open and fund a mutual fund account. This portion of the invention simplifies what would otherwise be a complex process, and coordinates the overall flow of the information between the three parties involved. An account form is filled out on-line through the internet site built by the financial service provider. The account form presented to the client investor requests only pertinent information for the particular account selected by the investor.

In this portion of the system, the account requirements will be provided (block 60) and the account type will be designated (block 62).

The data requested of the client investor is based on the particular type of account being opened as well as the funding source. As an example, if an individual account is being opened, the account application would reflect a single applicant as opposed to joint applicants. Questions about the source of funds will focus on the pertinent information relative to the particular source of funds.

The new account application requests affirmation by the client investor of certain requirements, such as: that they are a U.S. citizen or permanent resident, that they have a social security number and a U.S. address, and confirmation that the particular fund prospectus has been read. If all the requirements are met, the application proceeds to request pertinent data from the client investor relative to the particular account selected (block 64).

One issue concerns whether the account is to be an IRA or a regular taxable account. Additional account distinctions are possible, with each specific account requiring different information. For instance, if the account is for an IRA, a designated beneficiary will be required. The selected funding of the account will also generate particular questions for the client investor, depending upon whether the funding is a new contribution, a rollover or a transfer, or some other funding type. All of the necessary forms/requests and associated information are in the new account application information.

Once the information is acquired from the investor client, the system automatically writes that information to the appropriate fields in an actual new account application form for the financial services provider. The information includes the particular dollar amount of the investment being made and the particular investment solution selected by the investor. The client investor then has the opportunity to review the completed application (block 70) and then a final hard-copy application will be produced. When the application is acceptable to the investor client (block 72), the application is transmitted to a server at the location of the financial service provider.

From this point, much of the information and the remainder of the process is handled by the financial service provider. A confirmation number for the new account is provided to the investor client and the financial intermediary by the financial service provider. All of this is accomplished automatically by the financial service provider.

With the present system, there is no need to enter the required data more than once. This is a significant advantage over existing investment systems, even relative to investment systems which may use the internet. Once the new account application is completed, as outlined above, it is printed out and the client signs the application, if it is acceptable. The investment representative at the financial intermediary makes a copy of the application for the records of the financial intermediary. The application is then mailed to the financial service provider along with the required funds (block 74). This is the extent of the further involvement of the financial intermediary in the described transaction.

All of the information, including the application, is present in the records of the financial service provider. The financial service provider, following receipt of the application and the required funds, activates the client data on its server and the account is opened. It is now an active account. The financial service provider then establishes the necessary records to keep track of and report to the client investor on most aspects of the investment account.

The system of the present invention thus permits an investment transaction to be initiated, reviewed and completed over the internet. The account is opened with only a single entry of data, thus reducing the cost of administration, since it reduces the amount of time spent on the actual mechanics of the transaction.

Hence, a system has been described for actual use by financial intermediary organizations, such as banks or broker/dealers, which serve a large number of small individual client investors. The system, using the internet capability with internet sites tailored to, but separate from, the sites of the financial intermediaries, permits a small client investor, working with the financial institution, to make an informed investment decision, which is then administered by a financial service provider, which hosts the system for the benefit of the financial intermediary. This arrangement reduces costs for the financial intermediary and increases the chances of the financial intermediary making a profit with small accounts.

Although a preferred embodiment of the invention has been disclosed herein for purposes of illustration, it should be understood that various changes, modifications and substitutions may be incorporated in the embodiment without departing from the spirit of the invention, which is defined by the claims which follow.

What is claimed is:

1. A system for managing small investment accounts involving a financial service provider, a third party financial intermediary and client investors associated with the financial intermediary, using a global computer network, wherein the system is hosted on behalf of one or more financial intermediaries, the system comprising:
a first portion, available on the global computer network, which includes a series of questions to be answered by a client investor, directed toward determining a risk profile of the client investor, permitting a corresponding investment recommendation to be made by the system from a plurality of possible investments;
a second portion, available on the global computer network, for providing selected information concerning said investment recommendation; and
a third portion, available on the global computer network, for completion of an investment application by the client investor and for subsequent transmittal thereof to the financial service provider, which opens and maintains an investment account for the client investor on behalf of the financial intermediary with little further involvement by the financial intermediary.

2. A system of claim 1, wherein the financial intermediary has a plurality of client investors serviced by the system.

3. A system of claim 1, wherein the possible investments are proprietary products of the financial service provider.

4. A system of claim 1, wherein the possible investments include non-proprietary products relative to the financial service provider.

5. A system of claim 1, including another portion, available on the global computer network, which provides educational information and selected disclosure information concerning investments and information concerning particular investment products available from the financial service provider.

6. A system of claim 1, wherein the first, second and third portions are available at a global computer network site maintained by the financial service provider, which is separate from a network site maintained by the financial intermediary, wherein the financial service provider's network site is linked to the financial intermediary's network site.

7. A system of claim 6, wherein each financial intermediary serviced by said financial service provider has a separate network originated and maintained by the financial service provider, each of said network sites being customized to resemble the associated financial intermediary's network site.

8. A system of claim 1, wherein the individual client investor has the ability to change the risk profile and/or the investment recommendation to a selected extent.

9. A system of claim 6, wherein one or more of said system portions, when printed from the network site, have a space for a signature by the client investor.

10. A system of claim 1, wherein the financial system provider maintains complete records concerning each investment made for each said client investors and provides periodic reports to each client investor concerning their investments.

11. A system of claim 6, wherein the system includes means for automatically completing a new account application in response to data entered by the client investor at the network site.

12. A system of claim 11, wherein following completion of the new account application and approval thereof by the client investor, said account application form is transmitted to the financial service provider, which in return provides the client investor a confirmation number which correlates with the new application.

13. A system of claim 12, wherein the financial service provider, following receipt of a signed copy of the new application with necessary funds, opens an account for the client investor without significant entry of any information.

14. A system of claim 1, wherein the first portion includes a series of multiple choice questions, the result of which is tabulated by the system into a numerical value representing the risk profile of the client investor.

15. A system of claim 1, wherein the second portion includes information concerning the risk profile of a typical investor in the recommended investment, and other selected characteristics of the recommended investment.

16. A system of claim 1, wherein the recommended investment is selected from a plurality of mutual fund investments.
